(19) United States
(12) Patent Application Publication
(10) Pub. No.: US 2004/0207213 A1
(43) Pub. Date: Oct. 21, 2004

(54) Hasp for preventing accidental opening of a door

(76) Inventor: Raymond J. Brosseau, Courtice (CA)

Correspondence Address: BIRCH STEWART KOLASCH & BIRCH, PO BOX 747, FALLS CHURCH, VA, 22040-0747, US

(21) Appl. No.: 10/825,314

(22) Filed: Apr. 16, 2004

(30) Foreign Application Priority Data
Apr. 16, 2003 (CA) 2,425,675

(51) Int. Cl. E05B 67/36; E05C 19/08

(52) U.S. Cl. 292/281

(57) ABSTRACT

The hasp prevents the door of a boxcar or a sea-going bin from accidentally opening. One end of the hasp is locked to the door jamb adjacent to the door. The other end has a U-shaped connector which is removable from the shank of the hasp so that it can be passed through an opening in a staple on the door in order to attach to connector to the door. The connector is reattached to the shank of the hasp by means of a key which passes through keyways in the connector and the shank. To discourage vandalism or theft, the key can only be removed from the keyways by destroying it either by means of a blow torch or by means of a special tool which is not available to the general public.

### FIELD OF THE INVENTION

This invention relates to hasps for preventing doors in containers from accidentally opening and more particularly to a heavy duty hasp for preventing doors of containers such as boxcars, sea-going bins and the like from accidentally opening.

### BACKGROUND OF THE INVENTION

Boxcars of freight trains are subject to sudden violent jerks when the brakes of the train are applied or when the train is starting or stopping. The doors of boxcars slide on tracks and when they are suddenly and violently jerked, they tend to slide back and forth. To prevent closed doors from sliding open, heavy duty hasps are attached to the doors and to the adjacent jambs of the boxcar or to the adjacent doors where there are two doors which slide toward and away from each other.

Typically, the hasp is welded to the sliding door of a boxcar and is attached to the adjacent jamb by means of a locking wedge and a seal. To open the door, the seal is broken so that the locking wedge can be removed. Once the wedge is removed the door can be opened.

Should the hasp become unusable through damage, prolonged exposure to the elements or otherwise, the weld must be broken so that the hasp can be removed from the sliding door. Once removed it must be discarded and replaced with a new hasp.

A hasp which is in common use has an opening defined, in part, by a C-shaped connector having openings for receipt of a pair of pins on the shank of the hasp. The connector is attached to a heavy-duty staple on the sliding door of a boxcar. Once attached, the connector is welded to the shank so that the hasp cannot be removed from the staple. The other end of the hasp is sealed to the jam of the doorway of the boxcar. Once the hasp is attached in this way, the door of the boxcar can only be opened by breaking the seal.

Numerous problems can be encountered at the time the connector is welded to the hasp. Welding often occurs under less than ideal conditions. The weather may be very cold or very wet and under such conditions, the weld may be defective. As well, skilled labour is required to weld the connector to the hasp and even under ideal weather conditions the weld may be defective if the welder lacks the necessary skill and experience for the task. If the weld is defective, it may fracture when the hasp is severely jerked and if it does fracture, the door will slide violently back and forth each time the train jerks. Such sliding can cause severe damage to the door or to the jamb.

Welding requires tools and equipment that are difficult to transport particularly in adverse weather conditions. For example, if there is a heavy accumulation of snow in the vicinity of the door of a boxcar, it may be very difficult to transport the tools and equipment close enough to reach the hasp.

I have invented a hasp that is not attached to a staple by welding. Rather a bolt or key serves to connect the hasp to the door. The key is simply dropped into an opening in the hasp and a non-removable frictional fastener is pushed on the end of the key to hold it in position. Skilled labour is not required for this task. The possibility that the hasp may not be installed properly is minimal unlike a conventional hasp where there is a very real possibility that it may not be correctly installed.

Despite the fact that no hand tools and very little time are needed to install my hasp, it is as effective at preventing accidental opening of a door as a conventional hasp.

### SUMMARY OF THE INVENTION

Briefly the hasp of my invention comprises an intermediate portion and a terminal portion at each end thereof. One of the terminal portions has a tongue in which is formed a passage. A connector has at least one branch provided with a keyway and is attachable to a staple on the door or door jamb of a boxcar. A key removably connects the connector to the tongue. The key is adapted to be received in the passage and keyway and has a fastener to prevent the key from separating from the passage and the keyway. The catch is selectively removable from the key to permit the entry of the key into the passage and keyway.

A second embodiment of the hasp comprises an intermediate portion and a terminal portion at each end thereof. One terminal portion is bifurcated into a pair of branches each having a keyway. The keeways are adapted to receive a key for removably securing the bifurcated terminal portion to a staple.

### BRIEF DESCRIPTION OF THE DRAWINGS

The hasp of the invention is described with reference to the accompanying drawings in which:

FIG. 1 is an elevation of the hasp in conjunction with the door and side wall of a railway boxcar;

FIG. 2 is a perspective view of one embodiment of the hasp;

FIG. 3 is an enlarged perspective view of a connector in conjunction with a hasp fastener;

FIG. 4 is an elevation of the components of FIG. 3 together with an end of the hasp and a key for interconnecting the connector to the hasp;

FIG. 5 is an elevation of the hasp together with the hasp fastener, connector and key; and

FIG. 6 is a second embodiment of the hasp of the invention shown in conjunction with a hasp fastener.

Like reference characters refer to like parts throughout the description of the drawings.

### DESCRIPTION OF PREFERRED EMBODIMENTS

With reference to Figure, the side wall 10 of a boxcar is illustrated. The boxcar has a sliding door 12 which slides on tracks (not illustrated) at the bottom and top of the door. The door is shown in its closed position against a door jamb 14 which is part of side wall of the boxcar.

The door is secured in its closed position by means of a locking mechanism 16 which is is affixed to the door jamb. A hasp fastener 18, generally 18, is attached to the door and a hasp 20 interconnects the locking mechanism to the hasp fastener.

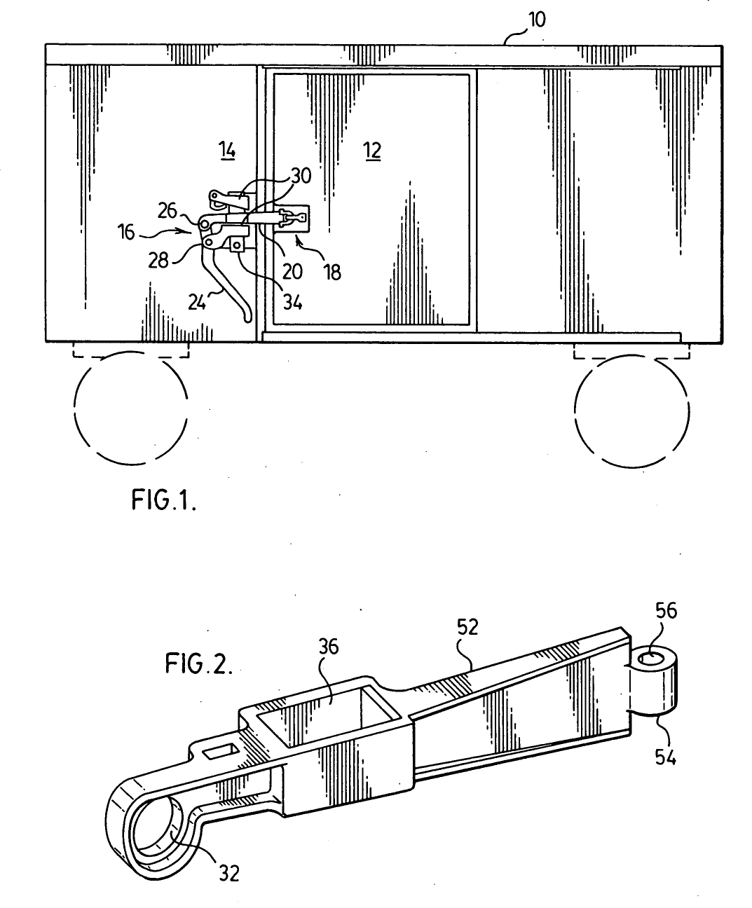

Locking mechanism 16 is conventional and has been used with minor modifications and improvements on boxcars of railways for many years. Basically, the mechanism has a lever 24 which has a pair of pins, 26, 28. Lower pin 28 is pivotally attached to the lower of a pair of spaced wings 30 while the upper pin 26 is pivotally attached to a ring 32 (FIG. 2) at one end of the hasp.

Each wing has a recess for receipt of a wedge pin 34 which is also received in a recess 36 in the hasp. The wedge pin serves to secure the hasp to the wings. A seal (not illustrated) below the wedge pin prevents the wedge pin from being removed from the recesses unless the seal is broken.

Lever 24 serves to draw the hasp to the left in order to close the door of the boxcar tightly against the jamb.

Examples of locking mechanisms similar to or the same as the one described above as shown in a number of patents including U.S. Pat. No. 3,279,839 issued Oct. 18, 1966 to Madland and U.S. Pat. No. 4,423,896 issued Jan. 3, 1984 to Loomis.

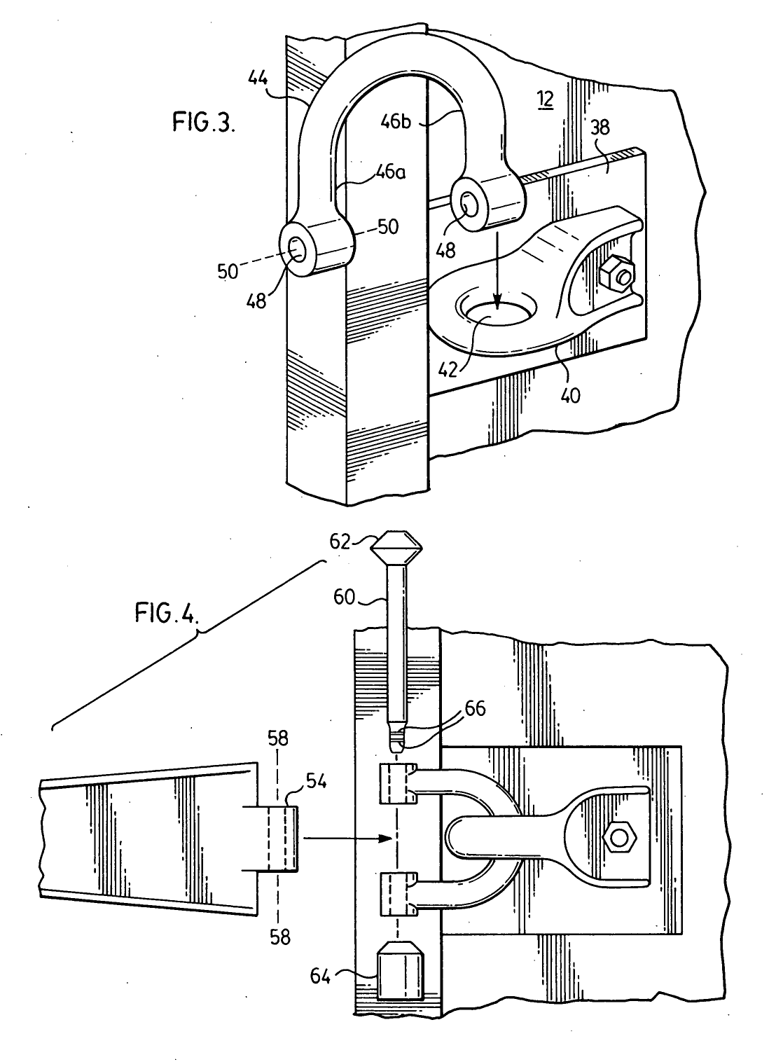

With reference to FIGS. 3 and 4, hasp fastener 18 includes a backing plate 38 which is secured by rivets or otherwise to door 12. A conventional heavy duty staple 40 is bolted to the backing plate. The staple has an aperture 42 through which a connector 44 of the hasp passes.

The connector is semi-circular in shape and has a pair of spaced apart branches 46a,b each having a keyway 48. The keyways have longitudinal axes 50-50 which are aligned with one another.

With reference to FIGS. 2, 3 and 4, the hasp has an elongated intermediate portion 52 and at the end opposite ring 32 is a barrel or tongue 54 having a passage or opening 56. The passage has a longitudinal axis 58-58.

The connector is attached to staple 40 by passing one of its branches through the aperture in the staple and positioning the connector such that the axes of its keyways are aligned with the longitudinal axis of passage 56. The connector and staple are then attached by passing the shank of a bolt or key 60 through the aligned keyways and passage.

Both ends of the key are enlarged to prevent the key from separating from the keyways and passage. The upper end is enlarged by a head 62 while the lower end is enlarged by a removable cylindrical fastener 64. The fastener has a circular longitudinally extending opening defined by an inside wall in which a pair of spaced apart annular grooves or hollows (not illustrated) is formed. Equally spaced apart annular ridges or catches 66 are formed adjacent to the lower end of the key.

The annular ridges or catches are resiliently deformable and yield to allow the fastener to be attached to the key by inserting the lower end of the key into the opening in the fastener and pushing the lower end of the fastener upwardly to cause the fastener to rise with respect to the key until the annular ridges reach the grooves at which time they snap into the grooves and thereby secure the fastener to the key.

To discourage vandalism or theft, fastener 64 is constructed such that once it is attached to the key, it must be destroyed to remove it. It cannot simply be pulled off by hand. The fastener can only be removed by means of a blowtorch or by a tool especially designed for this purpose. Such a tool is available from E. J. Brooks Industries Ltd. of Strathroy, Ontario, Canada and is identified by part number 9254043. The fastener and key 60 to which the fastener is attached are also available from the same firm and are called a “trans rod with seal”, part number 9254065.

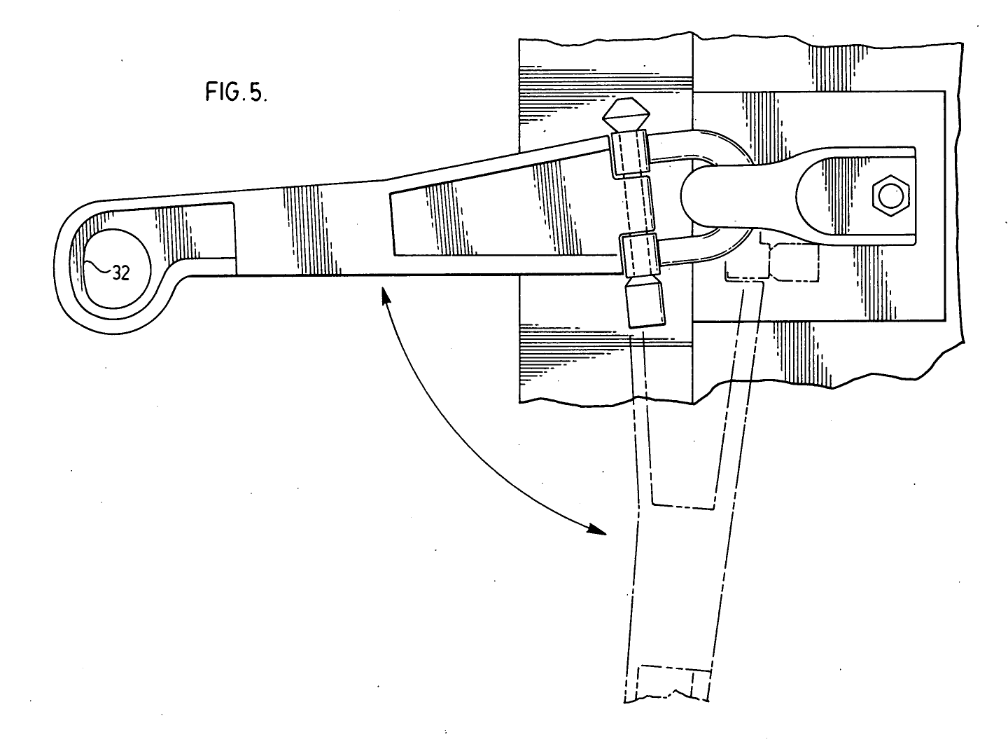

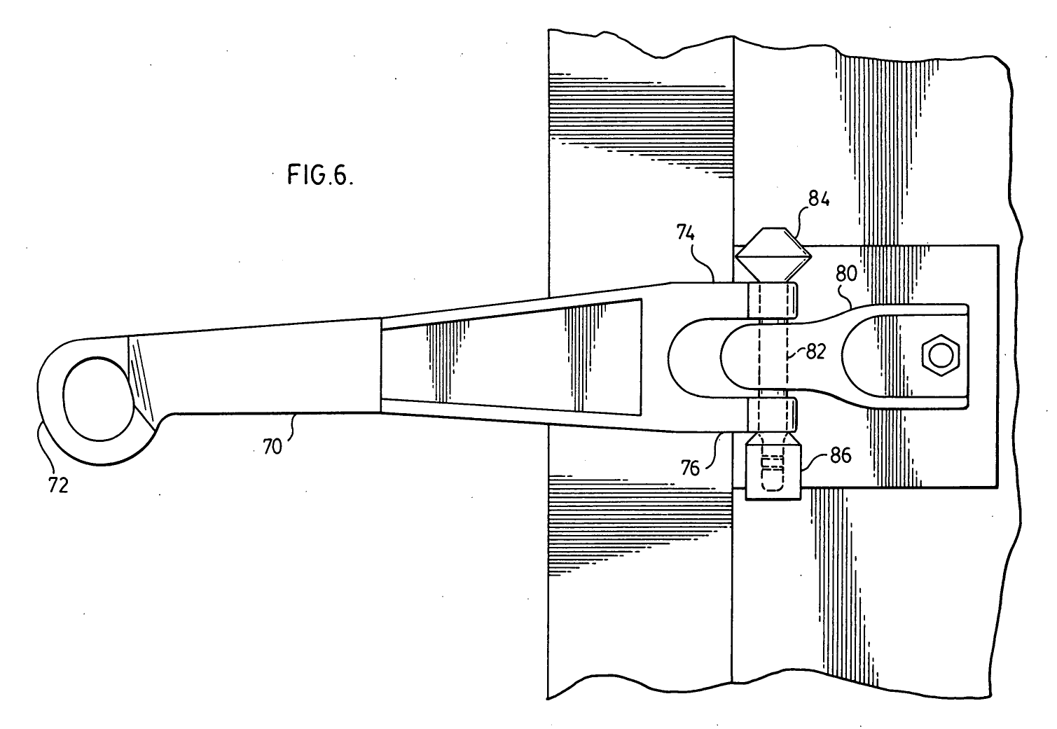

With reference to FIG. 5, when the hasp is connected to the staple, it may be pivoted upward and downward in the direction of the arrow when its ring 32 is not connected to the locking mechanism on the doorjamb. Being pivotal, the hasp can be used to interconnect a locking mechanism that is misaligned with a hasp fastener.

With reference to FIG. 6, hasp 70 has a conventional ring 72 at one end. The opposite end of the hasp is bifurcated into two branches 74, 76. Each branch has a hollow keyway having a longitudinal axis which align with one another and with the axis of the opening in staple 80 when the branches straddle the staple as illustrated. A key 78 can be used to connect the hasp to the staple.

Like key 60, both ends of key 82 are enlarged to prevent the key from separating from the keyways and the opening in the staple. The upper end is enlarged by a head 84 while the lower end is enlarged by a removable cylindrical fastener 86. Both keys 60, 84 have the same construction as have fasteners 64 and 86.

It will be understood, of course, that modifications can be made in the structure of the hasps of my invention without departing from the scope and purview of the invention as defined by the appended claims.

I claim:

1. A hasp for preventing the accidental separation of a door from an adjacent jamb, either one of the door or the jamb having means for removably securing the hasp thereto and the other having a staple in which is formed an aperture, said hasp comprising: an intermediate portion and a terminal portion, said terminal portion having a tongue in which is formed a passage; a connector having at least one branch in which a keyway is formed, said connector being attachable to said staple; and a key for removably connecting said connector to said tongue, said key being adapted to be received in the passage and keyway, said key further having a fastener to prevent said key from separating from said passage and said keyway, said fastener being selectively removable from said key to permit the entry of said key into the passage and keyway.

2. A hasp for preventing the accidental separation of a door from an adjacent jamb, either one of the door or the jamb having means for removably securing the hasp thereto and the other having a staple in which is formed an aperture, said hasp comprising: an intermediate portion and a terminal portion, said terminal portion having a tongue in which is formed a passage; a connector having at least one branch in which a keyway is formed, said connector being attachable to said staple by passing said branch through the aperture in said staple; and a key for removably connecting said connector to said tongue and being adapted to be received in the passage of the tongue and in the keyway of the branch, said key further having a fastener to prevent the removal of said key from said passage and said keyway, said fastener being selectively removable from said key to permit the entry of said key into the passage and keyway.

3. A hasp for preventing the accidental separation of a door from an adjacent jamb, either one of the door or the jamb having means for removably securing the hasp thereto and the other having a staple in which is formed an aperture, said hasp comprising: an intermediate portion and a terminal portion, said terminal portion having a tongue in which is formed a passage having a longitudinally extending axis; a connector having a pair of spaced branches in each of which is formed a keyway, the keyways in said branches having longitudinally extending axes which are aligned with one another and which are aligned with the axis of said passage when said tongue is located between said branches, said connector being attachable to said staple by passing one said branch through the aperture in said staple; and a key for removably connecting said connector to said tongue, said key having a shank adapted to be received in the passage and the keyways, when aligned, said key having a fastener to prevent the removal of said key from said keyways and said passage, said fastener being selectively removable to permit the entry of said key into the passage and the keyways.

4 The hasp of claim 3 wherein either said fastener or said shank has a resilient catch and the other has a hollow for receipt of said catch, said catch when received in said hollow acting to lock said fastener to said shank, said catch being attachable to said hollow by applying a force, opposed to the bias of said catch to cause said catch to enter said hollow.

5. A hasp for preventing the accidental separation of a door from an adjacent jamb, either one of the door or the jamb having means for removably securing the hasp thereto and the other having a staple in which is formed an aperture, said hasp comprising an intermediate portion and a terminal portion, said terminal portion being bifurcated into a pair of branches each having a keyway, and a key adapted to be received in said keeways and said aperture and acting to removably securing said bifurcated terminal portion to said staple.

6. The hasp of claim 5 wherein said keyways each have a longitudinal axis aligned with one another

7. The hasp of claim 6 wherein said keeways are spaced apart from each other and are adapted to straddle said staple, said key being receivable in said keyways and in said aperture for removably securing said hasp to said staple.
